(19) United States
(12) Patent Application Publication
(10) Pub. No.: US 2020/0021696 A1
(43) Pub. Date: Jan. 16, 2020

(54) MULTI-FUNCTION PRINTER AND A METHOD OF OPERATING THEREOF

(71) Applicant: TOSHIBA TEC KABUSHIKI KAISHA, Tokyo (JP)

(72) Inventor: Ajay SRIVATSA S., Bangalore (IN)

(73) Assignee: TOSHIBA TEC KABUSHIKI KAISHA, Tokyo (JP)

(21) Appl. No.: 16/171,031

(22) Filed: Oct. 25, 2018

(30) Foreign Application Priority Data
Jul. 11, 2018 (IN) 201841025860

(51) Int. Cl. H04N 1/00; G06F 3/12; G06K 7/10

(52) U.S. Cl. CPC H04N 1/00342; G06F 3/1204; H04N 2201/0094; G06K 7/10415; G06F 3/1231

(57) ABSTRACT

A Multi-Function Printer and a method of operating a Multi-Functional printer are described. The Multi-Function printer includes a plurality of RFID sensors, a RFID Reader, a memory and a processor communicatively coupled to the memory. Each of the plurality of RFID sensors transmits a tag identifier to the processor via the RFID reader. The processor then generates encrypted unique codes and transmits to each of the plurality of RFID sensors through the RFID reader. When a user swipes the RFID sensors, the encrypted unique codes from the activated RFID sensors are transmitted to the processor through the RFID reader. The processor decrypts the codes and compares whether the decrypted codes are same as prestored unique codes. Based on the comparison, the processor performs a function on a Multi-Function Printer.

### TECHNICAL FIELD

The present subject matter is related in general to Multi-Function Printer (MFP), more particularly, but not exclusively, to a Multi-Function Printer with Radio Frequency Identification (RFID) sensors and a method of operating the Multi-Function Printer.

### BACKGROUND

Multi-Function Printers (MFPs) have taken territory in today's home and business offices due to their quality, versatility, reliability, ease of use, small size, and the improvements they bring to productivity. As the name implies, the MFP can perform multiple functions such as advanced printing, facsimile, scanning, photocopying and the like. Owing to the performance and advantages, utilization of MFP has grown tremendously in recent years.

Controlling the various functions of MFP is being done by a touch display panel present on the body of the MFP. The touch display acts as input device which is used for various functions like user authentication, giving print commands, controlling brightness and the like. The touch display panel is costly and not always reliable as the touch display is prone to problems. For example, in a display panel, a hacker could easily determine the PIN code by identifying the fingerprint impression of the user on the display panel. By correlating the fingerprint with the keypad, the PIN code can be traced. It is also complex, tiresome and a waste of time for the user to navigate the various options in a touch display. Hence there is a requirement of alternative input device for controlling the functions of MFP.

The information disclosed in this background of the disclosure section is only for enhancement of understanding of the general background of some embodiments and should not be taken as an acknowledgement or any form of suggestion that this information forms the prior art already known to a person skilled in the art.

### BRIEF DESCRIPTION OF DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1 illustrates an exemplary overview of Multi-Function Printer in accordance with some embodiments of the present disclosure;

FIGS. 2a, 2b and 2c illustrate an exemplary overview of RFID sensors in accordance with some embodiments of the present disclosure;

FIG. 3 illustrates an exemplary representation of Multi-Function Printer with a plurality of RFID sensors in accordance with some embodiments of the present disclosure; and

FIG. 4 illustrates a flowchart for a method of operating a Multi-Function Printer in accordance with some embodiments of the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

In at least one embodiment, the present disclosure relates to a Multi-Function Printer (MFP) comprising a plurality of RFID sensors, a RFID Reader, a memory and a processor communicatively coupled to the memory. The memory stores processor instructions, which, on execution, causes the processor to receive a tag identifier from each of the plurality of RFID sensors through the RFID reader. The processor generates a unique code corresponding to each tag identifier of the plurality of RFID sensors and transmits the unique code to the respective RFID sensors through the RFID reader. The unique code is encrypted. In an embodiment, user provides an input by activating on one or more RFID sensors and the processor receives the unique code associated with one or more RFID sensors of the plurality of RFID sensors. The processor decrypts the unique code associated with the activated one or more RFID sensors and compares the decrypted unique code with prestored unique codes to obtain function corresponding to the decrypted unique code. In an embodiment, the processor performs action based on the obtained function.

In at least one embodiment, the present disclosure relates to a method of operating a Multi-Function Printer (MFP). The method comprises receiving, by the Multi-Function Printer, a tag identifier from each of a plurality of RFID sensors through a RFID reader and generating, by the Multi-Function Printer, a unique code corresponding to each tag identifier of the plurality of RFID sensors and transmitting the unique code to the respective RFID sensors through the RFID reader, wherein the unique code is encrypted. The method also comprises receiving, by the Multi-Function Printer, the unique code associated with one or more RFID sensors of the plurality of RFID sensors, wherein user provides an input by activating on one or more RFID sensors and decrypting the unique code associated with the activated one or more RFID sensors. The method further comprises comparing, by the Multi-Function Printer, the decrypted unique code with prestored unique codes to obtain function corresponding to the decrypted unique code and performing, by the Multi-Function Printer, actions based on the obtained function.

The present disclosure relates to a Multi-Function Printer (MFP) comprising multiple RFID sensors, a RFID reader and a processor. The RFID sensor maybe in form of RFID tags which may be easily attached to MFP. In an embodiment, the RFID sensors and readers may be used to recognize the user gestures in order to enable intuitive human-computer interaction. In at least one embodiment, the RFID sensors used are small inexpensive and un-intrusive passive RFID sensors which may be sensed from a few centimeters up to several meters. Passive RFID sensors operate without a battery and can be combined with multiple RFID sensors to transmit signals as input for MFP. Passive RFID-based location-sensing techniques may be used for localization of stationary tagged objects like the MFP. When the MFP is switched ON, the RFID sensors transmit a corresponding tag identifier to the RFID reader. The RFID reader transmits the tag identifiers to the processor. The tag identifier enables the processor to differentiate between the multiple RFID sensors. The processor generates an encrypted unique code corresponding to each of the tag identifier and stores the tag identifier along with the encrypted unique code in a memory of the MFP. The encrypted unique code is then transmitted to the multiple RFID sensors through the RFID reader.

The RFID sensors are activated when a user swipes or gestures over the RFID sensors. The activated RFID sensors transmit the encrypted unique codes given by the processor. The RFID sensors that are not swiped transmit the tag identifier only. The processor receives the encrypted unique codes and tag identifier and decrypts the encrypted unique code. The decrypted unique code is then compared with the prestored unique codes stored in the memory, by the processor. When there is a match, the processor performs function corresponding to the decrypted unique code. The MFP performs actions like printing, scanning, photocopying and the like corresponding to the function. The MFP action for corresponding unique code is pre-set. In at least one embodiment, the MFP is initially operated in authentication mode. The user should input his unique password on the plurality of RFID sensors. The plurality of RFID sensors are activated and transmit encrypted unique codes to the processor through the RFID reader. The unique codes corresponding to the password are decrypted by the processor and compared with prestored unique codes in memory. When there is a match, the processor authenticates the user to operate the MFP. In at least one embodiment, the processor blocks operation of the MFP temporarily after predetermined number of mismatch between decrypted unique code and prestored unique code. In at least one embodiment, a complete secure erase of data may be performed on MFP memory in case of a security breach. In at least one embodiment, the MFP action for corresponding unique code can be changed by the user. After the action is complete, the processor generates new set of encrypted unique codes to be transmitted to the RFID sensors via the RFID reader.

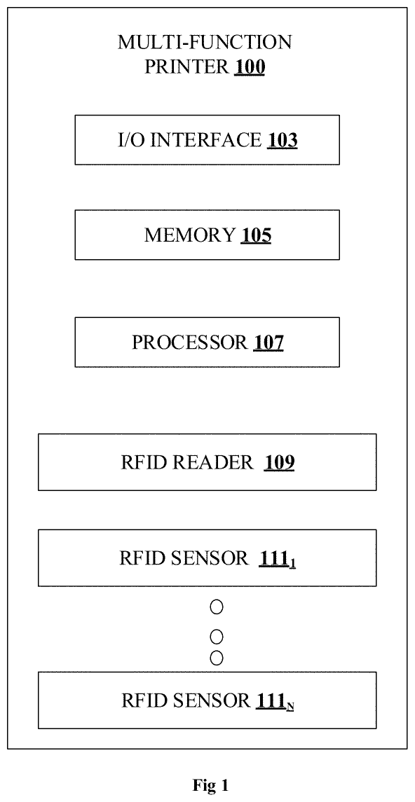

FIG. 1 illustrates an exemplary overview of Multi-Function Printer in accordance with some embodiments of the present disclosure.

In at least one embodiment, Multi-Function Printer 100 comprises a RFID reader 109, a RFID sensor 111₁, a RFID sensor 111₂ . . . a RFID sensor 111_{N}. In at least one embodiment, the RFID sensor 111₁, the RFID sensor 111₂ . . . and the RFID sensor 111_{N} are collectively referred as a plurality of RFID sensors 111. The plurality of RFID sensors may be at least one of touch based and gesture based. The gesture is defined as any physical movement, large or small, that can be interpreted by a motion sensor. Instead of typing with keys or tapping on a touch screen, the motion sensor perceives and interprets movements as the primary source of data input. Whenever a user makes a gesture by moving hands or fingers over one or more of the plurality of RFID sensors, corresponding one or more RFID sensors are activated. Further, a sequence of pre-stored unique codes corresponding to the activated one or more RFID sensors is generated. In at least one embodiment, the Multi-Function Printer 100 further comprises an I/O interface 103, a memory 105 and a processor 107. Multi-Function Printer (MFP) are devices that perform one or more functions such as, printing, facsimile, scanning, photocopying and the like. A person skilled in the art would understand that any known MFP device can be used with the present disclosure. Radio-Frequency Identification (RFID) is the use of radio waves to read and capture information stored on a sensor attached to an object. Data can be encoded in RFID sensors and can be captured by a RFID reader. The RFID sensors transmit the data in the form of radio waves. The RFID reader captures the radio waves and reads the data transmitted by the RFID sensors. For example, in gesture detection and identification, the RFID reader measures signal strength of the plurality of RFID sensors 111 and a tag identifier data table is created for corresponding to the plurality of RFID sensors 111. The MFP can also update the table based on user gesture input mechanism and improvise the same. Hence machine learning techniques can be applied for gesture detection and identification.

The I/O interface 103 may be configured to receive a tag identifier of the plurality of RFID sensors 111 from the RFID reader 109. The tag identifier from the I/O interface 103 may be stored in the memory 105. The memory stores encrypted unique codes and corresponding function for each unique code. The memory 105 may be communicatively coupled to the processor 107 of the MFP 100. The memory 105 may also store processor instructions which may cause the processor 107 to execute the instructions for operating the Multi-Function Printer (MFP) 100. The I/O interface 103 may also be configured to transmit to the RFID reader 109, encrypted unique codes generated for the plurality of RFID sensors 111 according to the corresponding tag identifier data. Further, the I/O interface 103 may receive encrypted unique codes of the one or more RFID sensors of the plurality of RFID sensors 111 from the RFID reader 109.

Each time the Multi-Function Printer (MFP) 100 is switched ON, the plurality of RFID sensors 111 transmit corresponding tag identifier to the RFID reader 109. The RFID reader 109 then sends the tag identifier of the plurality of RFID sensors 111 to the processor 107. The processor 107 receives the tag identifier of each of the RFID sensors through the I/O interface 103 and stores the tag identifier in the memory 105. Further, the processor 107 generates unique code corresponding to each tag identifier of the RFID sensors. In at least one embodiment, the processor 107 encrypts the unique code. In an exemplary embodiment, the encrypted unique code may be a string, a number, a special character, an alphanumeric character or any other coding convention used for encryption. A person skilled in the art would understand that any known encryption techniques may be used for encrypting the unique code. The encrypted unique code is transmitted to the plurality of RFID sensors 111 via the RFID reader 109.

Each of the plurality of RFID sensors 111 may be activated by swipe or gesture of user on the plurality of RFID sensors 111. In at least one embodiment, user swipes on one or more sensors of the plurality of RFID sensors 111, thereby activating the one or more sensors. The activated one or more RFID sensors transmit the encrypted unique code to the RFID reader 2109. One or more remaining RFID sensors of the plurality of RFID sensors 111 which are not swiped by the user send only the tag identifier data to the RFID reader 109. The processor 107 receives the encrypted unique code and the tag identifier and decrypts the encrypted unique code. The processor 107 then compares the decrypted unique code with the prestored unique code in the memory 105. When the decrypted unique code matches with the prestored unique code, the processor 107 obtains function to be performed corresponding to the decrypted unique code. In at least one embodiment, the processor retrieves function corresponding to the prestored unique codes from the memory based on the matched decrypted unique code. The function according to the unique code may be pre-set or set by the user. The MFP may perform one or more actions like printing, scanning and the like according to the retrieved function. After the action is completed, the processor 107 generates new encrypted unique codes to be transmitted to the plurality of RFID sensors 111 via the RFID reader 109.

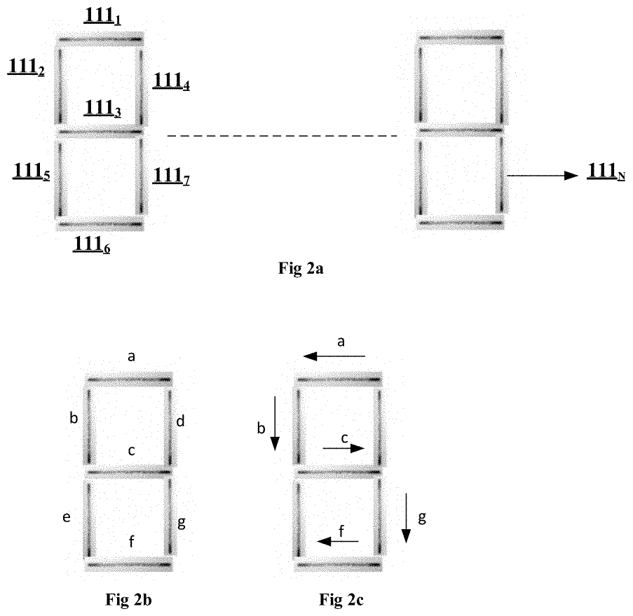

FIGS. 2a, 2b and 2c illustrate an exemplary overview of plurality of RFID sensors in accordance with some embodiments of the present disclosure.

In at least one embodiment, the plurality of RFID sensors 111 are arranged as shown in FIG. 2a. Each of the plurality of RFID sensors 111 transmits a tag identifier to a RFID reader 109 when the Multi-Function Printer 100 is switched ON. The RFID reader 109 further transmits the tag identifier to the processor 107. The processor 107 stores the tag identifier in memory 105 and generates an encrypted unique code corresponding to the tag identifier data of each of the plurality of RFID sensors 111. The encrypted unique code is transmitted to the RFID reader 109 by the I/O interface 103. Each of the plurality of RFID sensors 111 receives the encrypted unique code (a, b, c, d, e, f, g) from the processor 107 through the RFID reader 109. Exemplary encrypted unique codes corresponding to the RFID sensors are represented as shown in FIG. 2b. As an example, RFID sensor 111₁ receives ‘a’ as encrypted unique code, RFID sensor 111₂ receives ‘b’ as encrypted unique code and so on.

In real-time, one or more users of the MFP may interact with the MFP to perform one or more functions. Each of the plurality of RFID sensors 111 may be activated by at least one of touch and gesture of user. In an embodiment, user swipes on the one or more RFID sensors of the plurality of RFID sensors 111 as shown in FIG. 2c to enter a number (for example, number 5) as input. The RFID sensors (111₁, 111₂, 111₃, 111₇, 111₆) comprising unique codes a, b, c, g, f are now activated. The unique codes (a, b, c, g, f) are transmitted to the processor 107 via the RFID reader 109. The RFID sensors that are not activated by the user swipe (in this case 111₄, 111₅) transmit only the corresponding tag identifier. The processor 107 decrypts the unique code and compares the decrypted unique code with prestored unique code in the memory 105. When the decrypted unique code matches with the prestored unique code, the processor 107 determines a function corresponding to the decrypted unique code. In at least one embodiment, the processor retrieves function corresponding to the prestored unique codes from the memory based on the matched decrypted unique code. The MFP performs action corresponding to the function obtained using the decrypted unique code. In an embodiment, the MFP is initially operated in authentication mode (for eg: user input 0 from table 1). A unique password corresponding to each of the multiple users is stored in the memory 105. In an exemplary embodiment, the unique password may be 4-digit code. The user inputs the unique password on the plurality of RFID sensors 111. Now, the plurality of RFID sensors 111 are activated and transmit encrypted password to the processor 107 through the RFID reader 109. The unique password is decrypted by the processor 107 and compared with prestored unique passwords in the memory 105. When the unique decrypted password matches a prestored unique password, the processor 107 authenticates the user to operate the MFP to perform functions. The function of the MFP may be at least one of authenticating user of the Multi-Function Printer, maintenance of the Multi-Function Printer, changing modes of operation of the Multi-Function Printer, controlling brightness on user interface of the Multi-Function Printer, printing, scanning, facsimile and photocopying documents on the Multi-Function Printer. In an embodiment, the function of the MFP may be related to performing payment related services. The function according to the decrypted unique code may be pre-configured or changed dynamically. The function according to the unique code and swipe input of user is shown in Table 1 below. This table is an example and a person skilled in relevant art would understand that the MFP function can be configured differently for different user inputs on the plurality of RFID sensors. Also, different unique codes can be configured for different users. For example, unique code for printing function corresponding to a user may be a scanning function for another user.

TABLE 1

| User Input to RFID | RFID Sensors | Unique Codes | |
|---|---|---|---|
| Sensors | Activated | Transmitted | MFP Function |
| 5 | 111₁, 111₂, 111₃, | a, b, c, g, f | Printing |
| | 111₇, 111₆ | | |
| 6 | 111₁, 111₂, 111₅, | a, b, e, f, g, c | Scanning |
| | 111₆, 111₇, 111₃ | | |
| 7 | 111₁, 111₄, 111₇, | a, d, g | Photocopying |
| 0 | 111₁, 111₂, 111₅, | a, b, e, f, g, d | Authentication |
| | 111₆, 111₇, 111₄ | | |

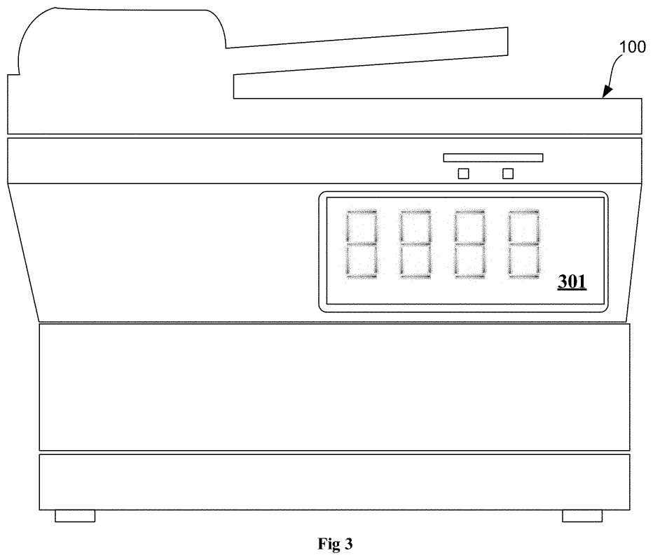

FIG. 3 illustrates an exemplary overview of Multi-Function Printer with a plurality of RFID sensors in accordance with some embodiments of the present disclosure.

In an embodiment, the Multi-Function Printer (MFP) 300 comprises a plurality of RFID sensors 111. The plurality of RFID sensors 111 may be placed in vicinity of the RFID reader. The plurality of RFID sensors 111 may act as input interface 301 of the MFP. The operation of the MFP may be controlled by input to the plurality of RFID sensors 111. As an exemplary embodiment, seven RFID sensors (111₁ to 111₇) are used to generate a single number as a user input. The plurality of RFID sensors 111 can be added as required to generate multiple numbers or alphabets as user input. In FIG. 3, the input interface 301 may be four digits or alphabets or a combination of both. A person skilled in the art would understand that any number of digits or alphabets may be used as input in the present disclosure. The user can swipe or gesture on any number of RFID sensors 111 to provide the input to the MFP. The unique codes transmitted to the processor 107 by user input as shown in Table 1 determine the function of MFP for that user input.

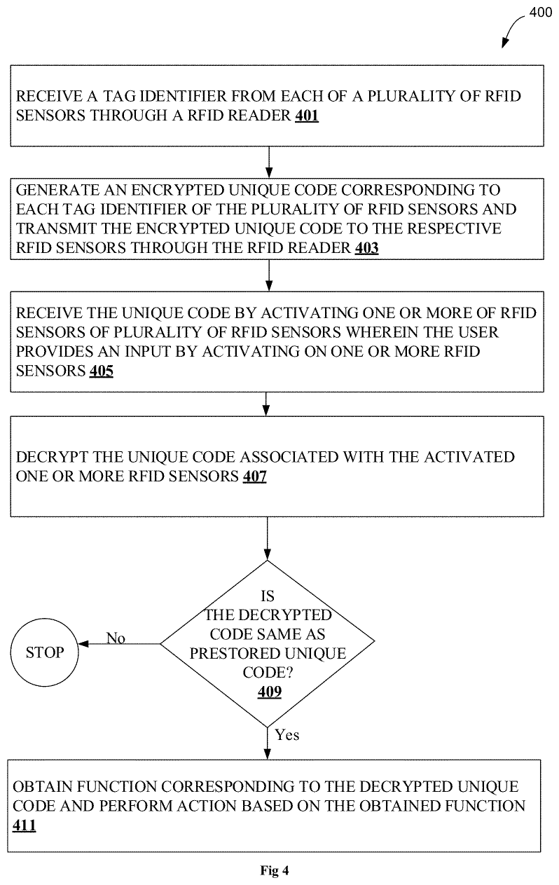

FIG. 4 illustrates a flowchart for a method of operating a Multi-Function Printer in accordance with some embodiments of the present disclosure.

As illustrated in FIG. 4, the method 400 includes one or more blocks for operating the MFP. The method 400 may be described in the general context of computer executable instructions. Generally, computer executable instructions can include routines, programs, objects, components, data structures, procedures, modules, and functions, which perform particular functions or implement particular data types.

The order in which the method 400 is described is not intended to be construed as a limitation, and any number of the described method blocks can be combined in any order to implement the method. Additionally, individual blocks may be deleted from the methods without departing from the spirit and scope of the subject matter described herein. Furthermore, the method can be implemented in any suitable hardware, software, firmware, or combination thereof.

At block 401, the processor 107 receives the tag identifier from each of the plurality of RFID sensors 111 through the RFID reader 109.

At block 403, the processor 107 generates an encrypted unique code corresponding to each tag identifier of the plurality of RFID sensors 111 and transmits the encrypted unique code to the respective RFID sensors through the RFID reader. The processor stores the tag identifier data and the encrypted unique code in memory 105.

At block 405, when the user activates one or more RFID sensors of the plurality of RFID sensors 111, the encrypted unique code of the activated one or more RFID sensors is transmitted to the processor 107 via the RFID reader 109. The plurality of RFID sensors 111 may be activated by swipe or gesture of the user on the plurality of RFID sensors 111.

At block 407, the processor decrypts the encrypted unique code associated with the activated one or more of RFID sensors.

At block 409, the processor compares the decrypted unique code with the prestored unique code and determines whether the decrypted unique code matches with prestored unique code. If there is a match, the processor proceeds to block 411. Otherwise, the processor stops operation.

At block 411, the processor obtains function corresponding to the decrypted unique code and performs action based on the obtained function. The MFP performs actions like printing, scanning and the like according to the obtained function. After the action is completed, the processor 107 generates new encrypted unique codes to be transmitted to the plurality of RFID sensors 111 via the RFID reader 109.

In at least one embodiment one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include Random Access Memory (RAM), Read-Only Memory (ROM), volatile memory, non-volatile memory, hard drives, CD ROMs, DVDs, flash drives, disks, and any other known physical storage media.

At least one embodiment of the present disclosure reduces cost of display panel in MFP.

At least one embodiment of the present disclosure reduces time in operating MFP by directly giving commands to the MFP from user swipe/gesture as input.

At least one embodiment of the present disclosure helps in maintenance of the MFP by configuring RFID tags.

At least one embodiment of the present disclosure helps in improving security of the MFP due to the implementation of locking of sensors temporarily after predetermined number of mismatch between decrypted unique code and prestored unique code.

The described operations may be implemented as a method, system or article of manufacture using standard programming and/or engineering techniques to produce software, firmware, hardware, or any combination thereof. The described operations may be implemented as code maintained in a “non-transitory computer readable medium”, where a processor may read and execute the code from the computer readable medium. The processor is at least one of a microprocessor and a processor capable of processing and executing the queries. A non-transitory computer readable medium may include media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), etc. Further, non-transitory computer-readable media include all computer-readable media except for a transitory. The code implementing the described operations may further be implemented in hardware logic (e.g., an integrated circuit chip, Programmable Gate Array (PGA), Application Specific Integrated Circuit (ASIC), etc.).

Still further, the code implementing the described operations may be implemented in “transmission signals”, where transmission signals may propagate through space or through a transmission media, such as, an optical fiber, copper wire, etc. The transmission signals in which the code or logic is encoded may further include a wireless signal, satellite transmission, radio waves, infrared signals, Bluetooth, etc. The transmission signals in which the code or logic is encoded is capable of being transmitted by a transmitting station and received by a receiving station, where the code or logic encoded in the transmission signal may be decoded and stored in hardware or a non-transitory computer readable medium at the receiving and transmitting stations or devices. An “article of manufacture” includes non-transitory computer readable medium, hardware logic, and/or transmission signals in which code may be implemented. A device in which the code implementing the described embodiments of operations is encoded may include a computer readable medium or hardware logic. Of course, those skilled in the art will recognize that many modifications may be made to this configuration without departing from the scope of the invention, and that the article of manufacture may include e suitable information bearing medium known in the art.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise. The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

A description of an embodiment with several components in communication with each other does not imply that all such components are required. On the contrary, a variety of optional components are described to illustrate the wide variety of possible embodiments.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments need not include the device itself.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

### REFERRAL NUMERALS

| Reference Number | Description |
|---|---|
| 100 | Multi-Function Printer |
| 103 | I/O interface |
| 105 | Memory |
| 107 | Processor |
| 109 | RFID Reader |
| 111₁-111_{N} | RFID Sensors |
| 301 | Input Interface |

What is claimed is:

1. A Multi-Function Printer comprising:
a plurality of Radio Frequency Identification (RFID) sensors;
a RFID Reader;
a memory; and
a processor communicatively coupled to the memory, wherein the memory stores processor instructions, which, on execution, cause the processor to:
receive a tag identifier from each of the plurality of RFID sensors through the RFID reader;
generate a unique code corresponding to each tag identifier of the plurality of RFID sensors and transmit the unique code to the respective RFID sensors through the RFID reader, wherein the unique code is encrypted;
receive the unique code associated with one or more RFID sensors of the plurality of RFID sensors, wherein a user provides an input by activating one or more RFID sensors;
decrypt the unique code associated with the activated one or more RFID sensors;
compare the decrypted unique code with prestored unique codes to obtain a function corresponding to the decrypted unique code; and
perform an action based on the obtained function, wherein the function is an action corresponding to operation of the Multi-Function Printer.

2. The Multi-Function Printer as claimed in claim 1, wherein the function comprises at least one of authenticating a user of the Multi-Function Printer, maintenance of the Multi-Function Printer, changing modes of operation of the Multi-Function Printer, controlling brightness on a user interface of the Multi-Function Printer, printing, scanning or photocopying documents on the Multi-Function Printer.

3. The Multi-Function Printer as claimed in claim 1 wherein the processor is configured to receive a tag identifier from the plurality of RFID sensors when the Multi-Function Printer is switched ON.

4. The Multi-Function Printer as claimed in claim 1, wherein the plurality of RFID sensors are at least one of touch based sensors or gesture based sensors.

5. The Multi-Function Printer as claimed in claim 1, wherein the processor is configured to receive the unique code associated with a respective RFID sensor only when the respective RFID sensor has been activated.

6. A method of operating a Multi-Function Printer comprising:
receiving, by the Multi-Function Printer, a tag identifier, from each of a plurality of Radio Frequency Identification (RFID) sensors through a RFID reader;
generating, by the Multi-Function Printer, a unique code corresponding to each tag identifier of the plurality of RFID sensors and transmitting the unique code to the respective RFID sensors through the RFID reader, wherein the unique code is encrypted;
receiving, by the Multi-Function Printer, the unique code associated with one or more RFID sensors of the plurality of RFID sensors, wherein a user provides an input by activating one or more RFID sensors;
decrypting, by the Multi-Function Printer, the unique code associated with the activated one or more RFID sensors;
comparing, by the Multi-Function Printer, the decrypted unique code with prestored unique codes to obtain a function corresponding to the decrypted unique code; and
performing, by the Multi-Function Printer, an action based on the obtained function.

7. The method as claimed in claim 6, wherein the function comprises at least one of authenticating a user of the Multi-Function Printer, maintenance of the Multi-Function Printer, changing modes of operation of the Multi-Function Printer, controlling brightness on a user interface of the Multi-Function Printer, printing, scanning or photocopying documents on the Multi-Function Printer.

8. The method as claimed in claim 6, wherein the tag identifier is received from the plurality of RFID sensors when the Multi-Function Printer is switched ON.

9. The method as claimed in claim 6, wherein the input to the plurality of RFID sensors is at least one of a touch based input or a gesture based input.

10. The method as claimed in claim 6, wherein the unique code associated with a respective RFID sensor is received only when the respective RFID sensor has been activated.

11. A non-transitory computer readable medium storing processor instructions, which when executed, cause a processor to perform a method of:
receiving a tag identifier from each of a plurality of Radio Frequency Identification (RFID) sensors through an RFID reader;
generating a unique code corresponding to each tag identifier of the plurality of RFID sensors and transmitting the unique code to the respective RFID sensors through the RFID reader, wherein the unique code is encrypted;
receiving the unique code associated with one or more RFID sensors of the plurality of RFID sensors, wherein a user provides an input by activating one or more RFID sensors;
decrypting the unique code associated with the activated one or more RFID sensors;
comparing the decrypted unique code with prestored unique codes to obtain a function corresponding to the decrypted unique code; and
performing an action based on the obtained function, wherein the function is an action corresponding to operation of the Multi-Function Printer.

12. The non-transitory computer readable medium as claimed in claim 11, wherein the function comprises at least one of authenticating a user of the Multi-Function Printer, maintenance of the Multi-Function Printer, changing modes of operation of the Multi-Function Printer, controlling brightness on a user interface of the Multi-Function Printer, printing, scanning or photocopying documents on the Multi-Function Printer.

13. The non-transitory computer readable medium as claimed in claim 11 wherein the method further comprises receiving a tag identifier from the plurality of RFID sensors when the Multi-Function Printer is switched ON.

14. The non-transitory computer readable medium as claimed in claim 11, wherein the plurality of RFID sensors are at least one of touch based sensors or gesture based sensors.

15. The non-transitory computer readable medium as claimed in claim 11, wherein the unique code associated with a respective RFID sensor is received only when the respective RFID sensor has been activated.
